(19) United States
(12) Patent Application Publication
(10) Pub. No.: US 2004/0214568 A1
(43) Pub. Date: Oct. 28, 2004

(54) Remote UltraWide Band communication system with short messaging and other functions

(75) Inventor: G. Smith Anderson, Haverhill, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: URAXS Communications, Inc., Haverhill, MA

(21) Appl. No.: 10/401,517

(22) Filed: Mar. 27, 2003

Related U.S. Application Data
(60) Provisional application No. 60/368,001, filed on Mar. 27, 2002.

(51) Int. Cl. H04Q 7/20

(52) U.S. Cl. 455/426.1; 455/404.1; 455/90.1

(57) ABSTRACT

A wireless communication system especially suitable for children utilizes Ultra Wideband (UWB) forward, Internet Protocol messaging (IPv6) and cellular communication technologies. The system comprises a UWB Mobile Remote Communication Device (MRCD) worn by a child. A Unified Receiver Translate Forward Module (URTFM) receives messages from the MRCDs and converts them to standard cellular signals, to physical layer signaling messages to a network, for delivery, for example, to the child's parent. Messaging options provided include an emergency notification and non-emergency standard unified messaging options. These and other delivery options may be pre-programmed via an interface using a webphone, voicemail or website. This eliminates the need for the child to know or dial telephone numbers, email addresses or the like.

### RELATED APPLICATIONS

This application claims the benefit of U.S. Provisional Application No. 60/368,001, filed Mar. 27, 2002. The entire teachings of the above application are incorporated herein by reference.

### FIELD OF THE INVENTION

The present invention relates generally to communication systems and in particular to an ultra wideband, remote unified message communication system especially suitable for use by small children.

### BACKGROUND OF THE INVENTION

Over the years, people have strived to improve their access to each other and to information through communication networks. While this at first involved only a voice telephone network available to a select few, technology now provides instant access to most things necessary and urgent to a wide cross section of the population. Vast networks serve our business and personal needs with cell phones, pagers, wireless Internet, and even an enhanced emergency response functions. These things are wonderful and an essential tool of our modern lives.

One thing that may have been overlooked however, with existing anywhere/anytime access networks, is our children. Our network and services are built by adults to serve adult needs and to be used primarily by adults. But this technology need not and should not be exclusive to use for adults. Rather, wireless applications should be adapted for young children's needs. Children live in a fragile world, and their loved ones want them to always have access to what they need as well. Sometimes a child just needs to say hello, and sometimes they need much more.

A recent study in Japan showed that among college, high school and middle school children who own cell phones, more that 88% use cell phones for sending email. While these numbers are amazing, what is truly interesting is how mobile media are changing they dynamics of how we coordinate, communication and share information among family and friends. For example, before initiating a wireless voice call to a friend, a child will—almost without exception—begin with a wireless text message to determine availability; the new social norm is that you should “knock before entering.” By sending messages like “Can you talk now?”, “Are you awake?”, or “Are you alone?” people spare each other the rude disruption of a sudden phone call.

While this study was done in Japan, this kind of high-volume yet simple communication is becoming more and more prevalent around the globe. As all people, but especially children, need to communicate more with others in their community, and as the content increases from lightweight text messages to more media-rich content (like sending Mom a photo of the shoes just purchased, or sending your best friend clips of that newly released hit song), the need for improved communication will only increase.

Conventional radio systems cannot expand to accommodate this growing use of bandwidth. The frequencies available for applications of conventional radio systems are limited in number and regulated heavily by government bodies around the world, including the Federal Communications Commission (FCC) in the United States. Unlike conventional radio systems, UltraWide Band (UWB) devices operated by employing very narrow or short duration pulses that result in very large, or wideband, transmission bandwidths. With appropriate technical standards, UWB devices can operate, perhaps even without a license, using the frequency spectrum occupied by existing radio services without causing interference, thereby permitting scarce spectrum resources to be used more efficiently.

In addition, the low cost of implementation for UWB devices enables providers to create scalable and dynamic network configurations that can grow as a function of the number of devices that need to be connected or as the coverage area varies. This “mesh” networking fundamentally allows each device in the network to act as both a user on the network and as a part of the network infrastructure. It also enables a single device to be “located” using standard time-domain locating algorithms.

### SUMMARY OF THE INVENTION

The present invention is a wireless communication system that can be configured as a messaging platform to interface with a unified messaging system. In this so-called Remote Unified Messaging System (RUMS), messages are initiated by a remote user via a wristwatch-like device—called a Mobile Remote Communication Device (MRCD)—that communicates with other wrist-worn devices or centralized smart nodes. The smart nodes, which are called Unified Receive-Translate-Forward Modules (URTFMs), are used to provide connectivity to the Internet or any other pervasive networking infrastructure.

In the preferred embodiment, the MRCD and URTFMs communicate with a physical layer protocol that uses UltraWide Band (UW) modulation techniques. Higher layer messaging is provided by layering link and transport layer protocols, so that standard network layer messaging protocols may be used over the UWB physical layer, such as Internet Protocol Version 6 (IPv6).

In one example application, the RUMS offers several levels of communication between two or more parties, and includes three messaging modes. The modes typically allow sending of pre-programmed messages representing increasingly higher levels of priority. For example, using an MRCD, a remote user who is a young child can send one of a number pre-programmed messages that she selects by simply pressing a button on the face of the wristwatch. At the lowest priority level, the child might send a simple “hello” or other similar message. A second mode can provide a medium-level priority message. A typical medium-level priority message would be a request from the child asking the parent to call. A high priority mode can typically be a dual function mode, which enables a single high-level priority message along with precise location data. A typical high priority message would be sent by a child to signal for help or to indicate trouble, for example.

URTFMs are typically located where the most end users tend to congregate for children this includes places like schools, churches, malls, and libraries.

The MRCDs preferably communicate these predetermined messages as coded network layer packets. In one example, the messages are coded as IPV6 messages. This allows the URTFMs to simply and rapidly route the messages received from the MRCDs to the parent or other destination associated in advance with a particular child. In particular, using routing information provided by a back end user configuration database, the URTFM can automatically forward a message to a predefined user and location, in a predetermined manner, depending upon the detected source MRCD address.

Thus, the child easily sends a message to a trusted recipient (such as their parent at home) via the appropriate network connection (Internet, cellular phone, wired modem, etc.) as designated in advance by the parent, without the need for the child to learn how to use cellular telephones, “Blackberry” e-mail type devices, pagers, and the like which may be too difficult or undesirable for the child to use. One benefit of an uncomplicated system like RUMS therefore is its ability to empower a user to communicate with pre-designated parties as easily as possible.

The MRCD can actually be a quite simple device with a one-button interface to activate pre-programmed messages. The system thus allows children as young as 4 or 5 years old, or the elderly, to initiate contact with their parents or other loved ones on their own, when and wherever they need to.

The MRCD can incorporate advanced features, such as store and forward, that will hold a message sent when the user is in a remote area, until a URTFM is again within range of the device.

Other features such as location tracking can be provided by triangulation functions available through the UWB physical layer, or via co-located Global Position System (GPS) equipment. Systems that have location information available can also support other functions such as perimeter control and the like.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of the short message system.

FIGS. 2A, 2B, and 2C are various views of a wrist-worn Mobile Remote Communication Device (MRCD).

FIG. 3 is a packet format diagram for a short message.

### DETAILED DESCRIPTION OF THE INVENTION

A description of preferred embodiments of the invention follows.

1. A Remote Unified Messaging System

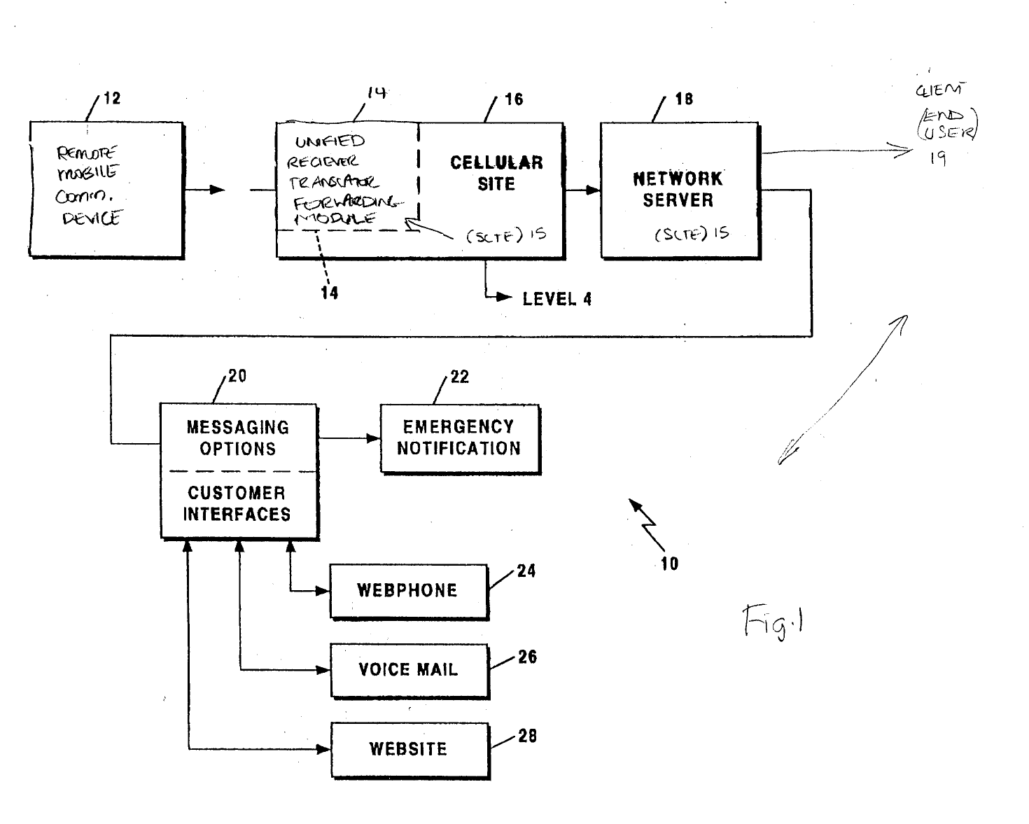

FIG. 1 is a block diagram of a Remote Unified Messaging System (RUMS) 10 that utilizes wireless packet data communication technology for the sending of predetermined messages and other information in a simple manner. The RUMS 10 has several major components, including a Mobile Remote Communication Device (MRCD) 12, a Unified Receive Translate Forward Module (URTFM) 14, a back-end website and database 20, 28, and optionally a Software Compression Transfer Engine (SCTE) 15,

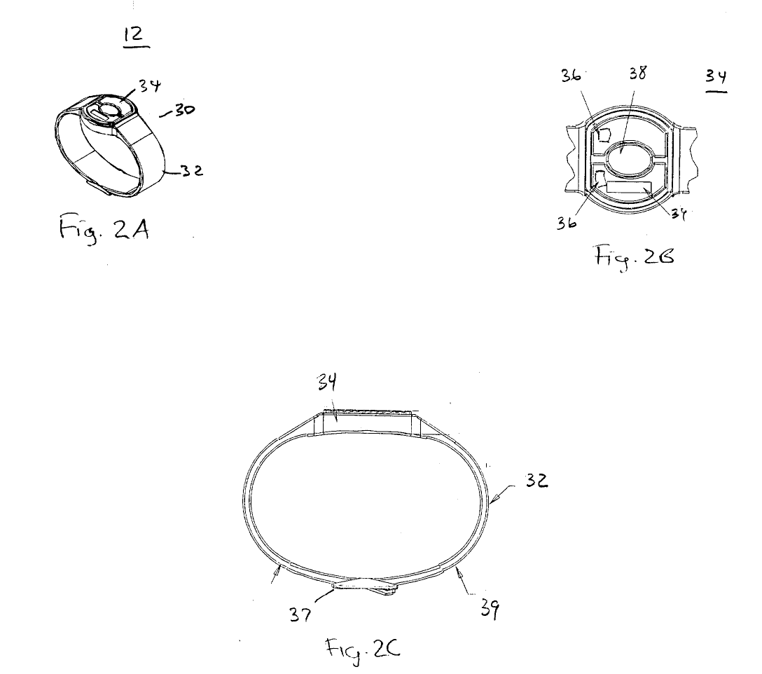

In one application of the RUMS to provide a unified messaging system for young children, a child wears a securely wrist-fastened Mobile Remote Communication Device (MRCD) 12 that serves as a transmitter/transponder. As best seen in FIG. 2, on its outer surface the MRCD 12 user interface comprises one or more pushbuttons 36 and may typically include a display 39 that provides a time of day clock. The MRCD 12 enables the child to send a selected one of several, perhaps three, pre-programmed message codes by pushing one of the buttons. Messages can be sent on an easily understood priority level as selected by the child, such as a priority 1, 2 or 3 message. As will be understood shortly, the remainder of the RUMS 10 is responsible for ensuring that the message is delivered to an intended recipient, such as the parent of te child, in a manner specified in advance by the parent. A simple message paradigm such as this is easy enough for a young child, perhaps from the ages of 4 to 10 years old, to comprehend and utilize effectively.

In general, the MRCD devices in the system communicate using an UltraWide Band (UWB) physical and/or link layer signaling and Internet Protocol (IP) based or the like network and higher layer signaling. By using a single IPv6 packet format for example, all of the data needed to send one of several selected predetermined messages can be encoded in one data packet which can then be routed to an intended destination using standard internetworking devices.

The MRCD 12 otherwise operates as a “dumb” terminal and simply transmits the pre-programmed messages to a Unified Receive Translate Forward Module (URTFM) 14 located at a central site 16. URTFMs are typically located at central sites where the most end users tend to congregate for a RUMS adapted for use by children this includes places like schools, churches, malls, and libraries.

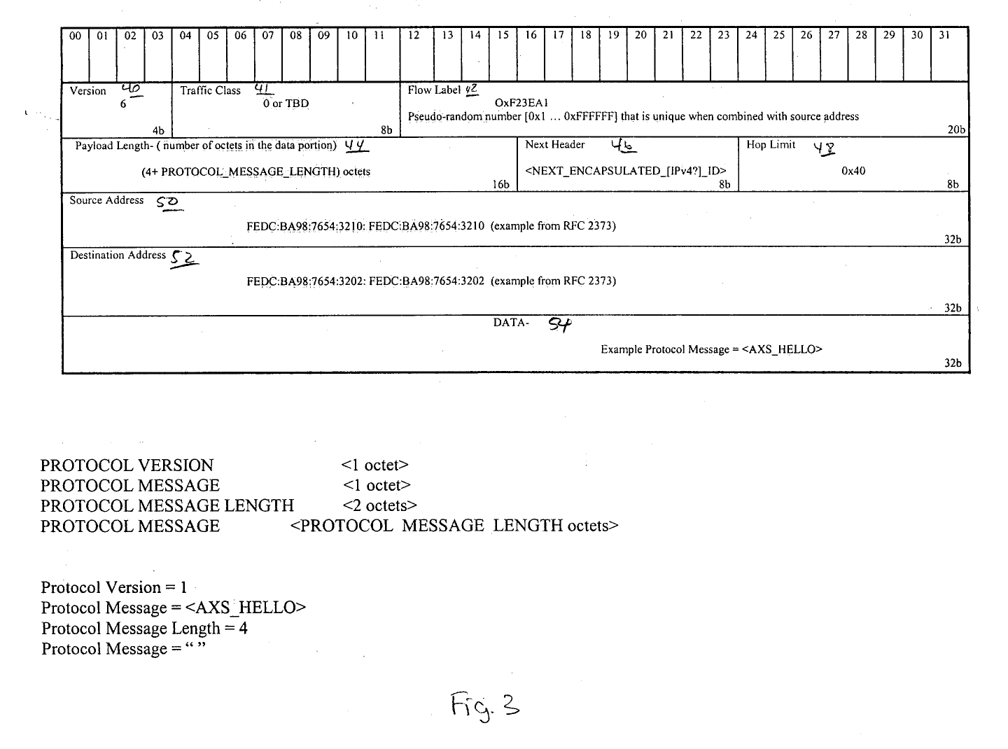

In a preferred embodiment, the MRCDs 12 transmit messages to the URTFMs as a single IPv6 packet over a UWB physical layer. The UWB physical layer may be provided in accordance with products and protocols now available and proposed by companies such as AetherWire and Location, Inc., of Sunnyvale, Calif.; Xtreme Spectrum of Vienna, Va.; and/or Time Domain Corporation of Huntsville, Ala. An example IPv6 packet format is shown and described in greater detail below in connection with FIG. 3.

The URTFM 14 acts as an intelligent network gateway, since is “knows what to do with” the messages received, through pre-programmed/re-configurable instructions, and will thus route them to the child's parent according to the level of urgency and user preference.

The group of MRCD's 12 located in a particular area may typically utilize networking functions inherent in certain UWB devices. For example, peer-to-peer, ad hoc mesh networks can be provided by a group of MRCD's 12 that are located near one another to assist with relaying of messages to a nearby URTFM 14.

It should also be understood that the MRCD 12 advantageously performs a store and forward function as well. Thus, for example, when a child or the user of the MRCD 12 is not within range of a URTFM 14 or part of the mesh network that can reach a URTFM 14, messages are stored within the MRCD 12, and then routed as soon as the device comes within range once again of the RUMS 10 infrastructure.

A Software Compression Transfer Engine (SCTE) 15 can optionally provide for compression of IPv6 layer messages as needed. This function can reside in the URTFM 14, the cellular site 15 or the network server 18.

In any event, in the preferred embodiment a URTFM 14 converts received UWB signals received from the MRCDs 12 to standard cellular (packet data or voice) signals. The converted signals are sent to and received by a network server 18. It should be understood that other types of connections can be provided between the URTFM 14 and the network server 18, such as wireless local area network (802.xx type networks), or even a wired network connection such as a T1 line or an Ethernet connection, although it is expected that various types of wireless connections would be preferred as being the most convenient to deploy.

The network server 18 is connected to a messaging options function 20 comprising customer network interfaces which interface with a web phone 24, voice-mail 26, or website 28. These interfaces allow the parent to specify how messages from the child are to be routed according to the parent's preference as to how to be notified, e.g., through telephone, e-mail, cell phone, pager, or other communication network. It is possible that this specification can change over time, e.g., in accordance with the parent's work schedule, so that the parent would receive messages in different places and manners according to the time of day or even the day of the week. The particular pre-defined priority for the message can also be used to control its manner of delivery.

2. Exemplary Messaging Paradigms

In one configuration, the MRCD 12 is a very basic three function communications device which sends messages according to a predetermined set. Several pre-programmed message types are possible. As one example, consider if the child presses the device button once in a five second time span to activate a selected priority level 1 message. A level 1 message could translate to “hello”, “miss you”, “goodnight”, or “I've arrived”. Such a low priority message might be sent in a manner that does not immediately interrupt a busy parent at work during the day time, and thus might be sent a an e-mail or a voice mail message.

Pressing the device button twice in a five second time span activates a level 2 message. A level 2 message might translate to “I need you (emotionally)”, “I have a problem, and please contact/I'm ready to be picked up”. This higher priority message might be specified by the parent to be sent in a more immediate manner, such as a page, an urgent e-mail or voice mail, as a phone call that might play a prerecorded audio message, or even a fax message. Again, the manner of delivery has been specified in advance by the parent according to the parent's wishes.

Pressing the device button three times in a five second time span or holding the button for a five second duration activates a priority level 3 message. A level 3 message can translate to “I'm in trouble”, I'm hurt”, I'm lost”, “send help/come to me”. This message would send out all available means of communication (cellular phone call, page, voice mail to the office, e-mail to a hand held Blackberry or Palm Pilot type device. Such a message might even trigger an emergency notification 22.

Delivery of all level 3 messages can be enhanced through repeaters located in all schools and public buildings, which is very possible through Federal assistance programs or tax credits.

The high priority, emergency notification 22 type message can also activate a GPS location of the MRCD 12 since the last level 3 message was activated, or make use of transmitter location functions inherent in certain UWB physical layer signaling. A typical example of a high priority message would be a child using the MRCD 12 to signal that he/she is in trouble, with the underlying UWB physical layer then automatically providing location information.

If the UWB protocol does not provide position or location information, a Global Positioning System (GPS) transponder associated with the URTFM 14 can also be used to provide approximate location information, and can even provide precision location information, if the MRCD 12 supports lock/confirmation protocols and radio signal triangulation.

Similarly, if a child or other remote user is unable to send a high-level help signal, but a parent suspects danger or a child is missing, the parent 19 can initiate a message to the URTFM 14, to request utilize the UWB transponders or other location system to help locate the whereabouts of a specific MRCD 12.

By the time stamping the message within the message sequence at the device level and a time division check between receivers, redundant instances can be canceled/rejected by the URTFM 14 after first confirmation of message recipient. This can help prevent the parent from receiving multiple copies of the same message from the child during a defined time interval, such as over the course of a few minutes.

Further functions can be provided for urgent priority 3 or higher messages. For example, if a high priority message originating from the MRCD 12 is not acknowledged by a client parent 19 within a selected time period, the URTFM 14 can send a notification to a secondary contact as designated by the parent 19. In the event that secondary contact does not respond, a cascade to message further contacts can be attempted, such as to reach emergency personnel if that is the choice of the parent 19.

Higher functionality can also include services such as those that negotiate a Supervisory Audio Tone (SAT)/Signaling Tone (ST) cellular channel through a preprogrammed protocol. By accessing the control channel, any cellular switch using any protocol can be accessed. Incorporating an antenna, the URTFM 14 and gateway software associated with a network server 18 provider's switch or router configuration makes it possible to interface with most if not all mobile carrier and emergency services. In this manner, a suitably equipped MRCD 12 and URTFM 14 would permit the transmission of voice or simple emergency messages or voice even communication, in the event that the child signals a level 3 “I'm in danger” type message.

The RUMS 10 can also support other types of messaging. For example, a multifunction full duplex mode can permit transmission of more complex, higher data rate messages using bit rate compression. For example, a Remote Audio Visual (RAV) functionality can be provided whereby remote sound and or video can be transmitted by the MRCD 12. Present technology makes this quite possible, given the small screen size associated with a wrist worn device (perhaps only 50 by 50 pixels), compression algorithms provided by one or more Software Compression Transfer Engines (SCTE) 15 (located in the MRCD, URTFM or elsewhere), and advanced cellular voice and/or packet data networks now emerging as so-called Third Generation (3G) type systems.

Still other functionality can be provided by the RUMS 10. For example, vital sign monitoring, barrier control such as to monitor the location of small children or prisoners under house arrest, hazardous material tracking, telemedicine and/or advanced security functions can be provided.

What is important to recognize is common among all of these messaging applications is that the client (parent) 19 specifies a manner in which messages originating at the MRCD 12 ought to be routed through the rest of the network, eliminating the need for the child or other user of the MRCD 12 to have to deal with such details. Through this unified messaging paradigm, the child user may direct a message using an appropriate communication system, be it an e-mail, a page, automated prerecorded call, voice mail message, facsimile, or other communication, not by having to understand how to use these different types of networks, but simply by selecting a message of a particular level of priority according to the child's own understanding. The service configuration is therefore highly personal between the child and parent and may even foster a better relationship through communication.

The end user customer 19 (parent) is able to program the system using the Internet, a phone, or voice mail to access a back end website 28 and message configurable database 20. Through the unified messaging system, the user 19 may direct the system as to the action to be taken when receiving a signal from the MRCD, such as what level of priority to ascribe to each message and whom to contact and in what manner. The main user interface for the service options is through a website 28 which can also serve as a point of sale.

3. The Wrist-Worn MRCD

The RUMS 10 thus permits a child having an MRCD 12 to communicate pre-programmed messages to a parent 19 at different levels of priority and, conversely, enables the parent, or law enforcement authorities in the case of abduction, loss or distress, to lock in to the device worn by the child to enhance the chances of recovering the child.

As shown in FIGS. 2A, 2B and 2C, the MRCD 12 is typically a wrist-watch type device 30 having a wrist band 32 and face 34. The face 34 has at least a number of buttons or other actuators 36. The actuators 36 allow even a child to select and send one of several predetermined messages as outlined above. The MRCD 12 contains internal circuitry that encodes the message and transmits it to the intelligent network server via the URTFM 14. Since the URTFM “knows” what to do with the messages received through the pre-programmed/re-configurable instructions according to the level of urgency and end user 19 preference, the user of the MRCD 12 need not understand or appreciate how to place calls on the cellular network 16, send e-mails, or the like.

The face 34 of the MRCD 12 may also provide space for other functions and/or information display such as a time 38 or message 39 display.

The MRCD 12 is typically made from durable packaging materials, so as to be able to withstand expected physical punishment that an aggressive child might inflict.

The MRCD 12 device is typically secure on a child through a suitable wrist band 32. The wrist band 32 may have a suitable latch 37 as is typical for a wrist watch. However, a break detector, such as a resistance wire or electrode 39 run through or adjacent the band, can enable circuits in the MRCD 12 to determine if the wrist band 32 is opened. This can be used to determine when the MRCD 12 is removed from the child without consent of the end user 19, to automatically send a distress message. The distress message would typically be a highest priority message routed to the parent end user 19, or optionally to the police or other officials responsible for the child's safety.

4. Message Packet Formats

This can perhaps be better appreciated by considering the format of a message packet sent between the MRCD 12 and the URTFM 14 as shown in FIG. 3. The illustrated IPv6 packet has various fields including a version 40, traffic class 41, flow label 42, payload length 44, next header 46, hop limit 48, source address 50, destination address 52, and payload or data field 54.

A sample message contained in the data field portion 54 includes a protocol header of 4 bytes: version (1 byte), message (1 byte), and message length (2 bytes). The protocol message section can be of a variable length. The illustrated example message has a version of “1”, predefined message of “AXS_HELLO” (value “1”), and message length of 4 (number of octets in the data portion).

The URTFM 14 would rely on the unique information contained in the flow label 42 to determine how to forward the message and to indicate other processing that might be needed for the message to reach the intended destination. In the simplest devices, translation to other protocols could be avoided and the flow label 42 is identified as a message that can be transferred to the network server 18 in its native IPv6 form. In such a configuration, the further processing might only consist of a confirmation ping or acknowledgment sent back to the MRCD 12.

With such a message format, the URFTM 14 can route the message simply based upon source 50/destination 52 address and flow label 42. In one implementation, the flow label 42 can be used as a stream ID, similar to an real Time Protocol (RTP) synchronization source. The flow label 42 can also be used to modify the traffic class field, to set message priority and distinguish routing algorithms based on data type within the MRCD 12/URFTM 14 “network”. The traffic class field 41 can thus be set to a specific value, which can be modified by routing elements.

There are many values that could be specified for the next header 46 field (which is specified in the IP documentation), depending on the embedded “next layer” protocol data. The next header field 46 for example, could be formatted as in a TCP or UDP protocol.

More sophisticated devices could require the translating and interfacing of the message, such as to accommodate cellular, cellular packet data, and/or 802.x wireless local area network protocols. These functions are inherent within the Media Access Control (MAC) and Link Layer functions of certain UWB vendor products such as AetherWire's.

It should be understood that the message format in FIG. 3 is exemplary only and other variants are possible. Thus, a version number may not be needed; other lengths might be selected for message ID and/or message lengths, and flags can be added into the header, perhaps to identify device, priority, etc.

5. Conclusions

A messaging system as described herein thus provides empowerment through simplicity of communication. We know that communication is a process by which information is exchanged between individuals through a common system of symbols, signs, behavior or the exchange of information. It can also be highly personalized and dependent upon the rapport of the ones engaged in such. Through specific tools, options and technology utilized by the invention, communication is now lifted to a new level of efficiency. The system is quite suitable for use by young children, elderly, or security personnel who are now empowered to communicate with those they trust at different priority levels.

The primary application of a first generation device can be a basic, three level preprogrammed configuration. Other than the primary application of child communication, such a device may serve as a beacon in an enhanced perimeter monitoring system that might be used in a school, hospital, day camp, prison, or other setting where the safety and security of a group of people is important.

The RUMS 10 and service may be offered in a relatively inexpensive manner due to the existing technologies and vast networks already in place. Capital investment required to implement such a system should therefore be a minimum. With millions of wireless customers already in place, the customer base is already a captive audience hungry for new applications. The UWB-based MRCD 12 device itself is relatively inexpensive, even when constructed from quality, durable materials suitable to withstand a child's abuse and to be worn always. The service may be offered as a stand alone or bundled with existing services.

While the RUMS 10 has been described as using a UWB physical layer with higher layer IPv6 messages, the RUMS 10 is not specific to any one form of wireless network or messaging protocol, but rather should be considered to be as cross-platform compatible as possible, without being completely open source, in order to preserve a higher level of integrity.

While this invention has been particularly shown and described with references to preferred embodiments thereof, it will be understood by those skilled in the art that various changes in form and details may be made therein without departing from the scope of the invention encompassed by the appended claims.

What is claimed is:

1. A wireless communication system comprising:
a remote communication device having one or more actuators, each actuator associated with a predetermined, human conversational message;
a message transcoder, connected to the actuators, for selecting a predetermined message packet upon a user selecting one of the actuators;
a wireless communication transmitter, for transmitting the selected predetermined message packet over a first, short range wireless network;
a receiver/translator forwarding module, arranged to receive the message packet from the first wireless network, and to forward the message packet over a second network; and
a network server, connected to receive the message packet from the second network, and to further forward the message to an intended network destination of a supervisory subscriber associated with the specific remote communication device.

2. A system as in claim 1 wherein the first wireless network uses UltraWide Band (UWB) modulation.

3. A system as in claim 1 wherein the second network is a wireless network.

4. A system as in claim 3 wherein the second network is selected from a group consisting of cellular mobile telephone, cellular packet data, and wireless local area network.

5. A system as in claim 1 wherein the second network is a wired network.

6. A system as in claim 1 wherein the receiver/translator forwarding module routes the message packet according to predetermined routing instructions specified by the subscriber.

7. A system as in claim 6 wherein the subscriber specifies different routing instructions to be carried out according to a priority associated with each message.

8. A system as in claim 6 wherein the subscriber specifies different routing instructions to be carried out according to a time of date associated with each message.

9. A system as in claim 1 wherein the wireless transmitter transmits packets over a secondary wireless network.

10. A system as in claim 1 wherein a packet message that is undeliverable, due to an out of range condition, is stored and forwarded once the unit is within a connection range of a receiver translator forwarding module.

11. A system as in claim 1 wherein each supervisory subscriber determines the predetermined set of human conversational messages to made be available for selection for users associated with that subscriber.

12. A system as in claim 1 wherein the user is a child and the supervisory subscriber is the child's parent.

13. A system as in claim 1 wherein UltraWide Band signaling is used within the first wireless network, and the system is used specifically for communication with children.

14. A system as in claim 13 wherein the receiver/translator forwarding module is located in a place where children regularly congregate, the place selected from a group consisting of a school, playground, church, or camp.

15. A system as in claim 1 wherein UltraWide Band signaling within the first wireless network is used for location of the user, and the user is a child.

16. A system as in claim 15 wherein, when a child user selects one of the predetermined messages indicating that the child is in danger, location information is provided with the forwarded message.

17. A system as in claim 1 wherein time stamp information is added to the message, and wherein the message is not forwarded if the same message has been routed within a predetermined time frame.

18. A system as in claim 1 wherein the user is a dependent person and the supervisory subscriber is a caretaker.

19. A method for wireless communication comprising the steps of:
providing a remote communication device with one or more actuators, each actuator associated with a predetermined, human conversational message;
selecting a predetermined message packet upon a user selecting one of the actuators;
transmitting the selected predetermined message packet over a first, short range wireless network;
receiving the message packet from the first wireless network, and then forwarding the message packet over a second network; and
receiving the message packet from the second network at a network server, and further forwarding the message to an intended network destination of a supervisory subscriber associated with the specific remote communication device.

20. A method as in claim 19 wherein the first wireless network uses UltraWide Band (UWB) modulation.

21. A method as in claim 19 wherein the second network is a wireless network.

22. A method as in claim 21 wherein the second network is selected from a group consisting of cellular mobile telephone, cellular packet data, and wireless local area network.

23. A method as in claim 19 wherein the second network is a wired network.

24. A method as in claim 19 wherein the routing step routes the message packet according to predetermined message routing instructions specified by the subscriber.

25. A method as in claim 19 wherein a packet message that is undeliverable, due to an out of range condition, is stored and forwarded once the remote unit is within a connection range.

26. A method as in claim 19 wherein the user is a child and the supervisory subscriber is the child's parent.

27. A method as in claim 19 wherein each supervisory subscriber determines the predetermined set of human conversational messages to made be available for selection for users associated with that subscriber.

28. A method as in claim 19 wherein UltraWide Band signaling is used within the first wireless network, and the system is used specifically for communication with children.

29. A method as in claim 19 wherein UltraWide Band signaling within the first wireless network is used for location of the user, and the user is a child.

30. A method as in claim 28 wherein the step of forwarding the message is carried out in a place where children regularly congregate, the place selected from a group consisting of a school, playground, church, or camp.

31. A method as in claim 29 wherein, when a child user selects one of the predetermined messages indicating that the child is in danger, location information is provided with the forwarded message.

32. A method as in claim 19 wherein time stamp information is added to the message, and wherein the message is not forwarded if the same message has been routed within a predetermined time frame.

33. A method as in claim 19 wherein the user is a dependent person and the supervisory subscriber is a caretaker.
